(19) United States
(12) Patent Application Publication
(10) Pub. No.: US 2023/0358367 A1
(43) Pub. Date: Nov. 9, 2023

(54) METHOD FOR KEEPING FREE OF ICE OR THAWING AT LEAST ONE SURFACE WHICH IS AT RISK OF ICING OF A TANK INTERFACE AND A TANK INTERFACE

(71) Applicant: Robert Bosch GmbH, Stuttgart (DE)

(72) Inventors: Mark Hellmann, Korntal (DE); Helerson Kemmer, Vaihingen (DE); Matthias Rink, Herrenberg (DE)

(21) Appl. No.: 18/246,369

(22) PCT Filed: Aug. 18, 2021
(86) PCT No.: PCT/EP2021/072892

§ 371 Date: Mar. 23, 2023

(30) Foreign Application Priority Data
Sep. 25, 2020 (DE) 10 2020 212 080.3

(51) Int. Cl. F17C 13/10

(52) U.S. Cl. CPC F17C 13/10; F17C 2221/012; F17C 2260/032; F17C 2265/065; F17C 2270/0168; F17C 2203/0607; F17C 2203/066

(57) ABSTRACT

The invention relates to a method for keeping free of ice or thawing at least one surface (1) which is at risk of icing of a tank interface (2), wherein the at least one surface (1) at risk of icing is formed on a refueling nozzle (3) and/or on a tank filler neck (4) of a vehicle which can be operated with hydrogen. According to the invention, the at least one surface (1) at risk of icing is heated during a refueling operation and/or after a refueling operation.

The invention further relates to a tank interface (2) and to a vehicle, which can be operated with hydrogen, having a tank interface (2) according to the invention.

### BACKGROUND OF THE INVENTION

The invention relates to a method for keeping free of ice or thawing at least one surface, which is at risk of icing, of a tank interface, wherein the at least one surface is formed on a refueling nozzle and/or on a tank filler neck of a vehicle which can be operated with hydrogen. The invention also relates to a tank interface comprising at least one surface at risk of icing which is formed on a refueling nozzle and/or on a tank filler neck of a vehicle which can be operated with hydrogen.

Hydrogen-powered fuel cell systems are said to have great potential to play a major role in the energy and transportation transition. The first series applications are already available on the market.

In mobile applications, hydrogen has to be carried along in a reservoir or tank. In principle, hydrogen can be stored at very low temperatures in a so-called cryotank or under pressure in a pressure tank. For mobile applications and applications in which there is no guarantee that hydrogen will be withdrawn continuously, pressure tanks are the preferred solution. The storage pressure in these pressure tanks can be up to 700 bar.

Once the stored hydrogen has been consumed, the tanks have to be refilled. To do this, a hydrogen-powered vehicle stops at a hydrogen filling station. Refueling is carried out with the aid of a refueling nozzle and a corresponding tank filler neck on the vehicle. This interface is internationally standardized and the standard is defined in the SAE J2601 protocol. Since hydrogen heats up during a refueling operation due to its thermodynamic properties, it is stored at the filling station at about −40° C. Therefore, when a vehicle is being refueled, the areas through which the cold hydrogen flows, in particular valves, pipes and/or connections, can cool to such an extent that they freeze. Moreover, ambient moisture can condense on the refueling nozzle as condensation, which then freezes. The refueling nozzle can consequently freeze to the tank filler neck during the refueling operation. The risk of freezing is particularly high when the vehicle is refueled in a warm, humid environment. Refueling operations carried out in quick succession also increase the risk, since the refueling nozzle does not have time to warm up.

### SUMMARY OF THE INVENTION

Since freezing of the refueling nozzle to the tank filler neck leads to extended refueling times, the underlying object of the present invention is to prevent freezing or at least make freezing more difficult.

To achieve said object, the method having the features according to the invention and the tank interface having the features according to the invention are specified. Advantageous further developments of the invention can be found in the respective subclaims. A vehicle which can be operated with hydrogen and comprises a tank interface according to the invention is specified as well.

Proposed is a method for keeping free of ice or thawing at least one surface which is at risk of icing of a tank interface. The at least one surface at risk of icing is formed on a refueling nozzle and/or on a tank filler neck of a vehicle which can be operated with hydrogen. According to the invention, the at least one surface at risk of icing is heated during a refueling operation and/or after a refueling operation.

Heating the at least one surface at risk of icing makes it possible to actively counteract icing of the tank interface, so that icing either does not occur at all or, if it does, the iced area can be thawed quickly. If the at least one surface at risk of icing is heated during the refueling operation, freezing of the refueling nozzle to the tank filler neck can be prevented. Heating can alternatively or additionally also be carried out after the refueling operation, so that the formation of condensation, in particular on the refueling nozzle, is counteracted. In this way, in the event of refueling operations carried out in quick succession, freezing of the refueling nozzle to the tank filler neck of the following vehicle can be prevented.

The refueling nozzle forms the filling station-side interface for refueling a vehicle with hydrogen. The tank filler neck forms the corresponding interface on the vehicle. The term “tank interface” can therefore refer to the refueling nozzle and/or to the tank filler neck.

When refueling a vehicle which can be operated with hydrogen, cold hydrogen flows via the refueling nozzle and the tank filler neck into a tank of the vehicle. Both the refueling nozzle and the tank filler neck can thus form at least one surface at risk of icing. The method according to the invention can thus be used to keep the refueling nozzle and/or the tank filler neck free of ice.

According to a preferred embodiment of the invention, the at least one surface at risk of icing is heated with the aid of a heating cartridge or a heating ring. These heating devices require little installation space and can thus also be installed in tight spaces. They are also very robust. The heating ring is particularly suitable for heating an outer or inner peripheral surface of the refueling nozzle and/or the tank filler neck.

Alternatively or additionally, it is proposed that the at least one surface at risk of icing is inductively heated. This type of heating is useful, because, in the area of their surfaces at risk of icing, the refueling nozzle and/or the tank filler neck are typically made of metal, and thus of an electrically conductive material. An inductive heating device also requires little space and can moreover be implemented in a simple and cost-efficient manner.

It is also possible to combine a number of heating methods, in particular if multiple surfaces at risk of icing on the refueling nozzle and/or tank filler neck are heated.

The tank interface also proposed to achieve the aforementioned object comprises at least one surface at risk of icing, which is formed on a refueling nozzle and/or on a tank filler neck of a vehicle which can be operated with hydrogen. The term “tank interface” can again refer to the refueling nozzle as the filling station-side interface and/or to the tank filler neck as the vehicle-side interface. According to the invention the at least one surface at risk of icing can be heated by means of a heating device and/or is designed in such a way that water is removed, absorbed or adsorbed in a targeted manner.

The at least one surface at risk of icing can be heated with the aid of the heating device if necessary, so that freezing of the refueling nozzle to the tank filler neck is prevented or ice that has already formed in the area of the tank interface is thawed. The formation of condensation can moreover be counteracted with the aid of the heating device, in particular if it is used to heat the refueling nozzle. This also helps to minimize the risk of freezing to a tank filler neck.

The heating device can be a heating cartridge or a heating ring, for example. The heating ring can in particular be used to heat an outer or inner peripheral surface of the refueling nozzle and/or the tank filler neck. Alternatively or additionally, it is proposed that the heating device is an inductive heater.

If a heating device is provided, the above-described method according to the invention can be carried out with the aid of the proposed tank interface. However, the tank interface according to the invention does not necessarily have to comprise a heating device.

The alternatively or additionally proposed measure provides a special property to the at least one surface at risk of icing. This is characterized in that it removes water, in particular condensation, from the area at risk of icing. The removal of water is effected passively, i.e. solely via the property of the surface. The risk of icing is minimized in this way as well.

The removal of water can in particular be achieved with a hydrophilic or hydrophobic surface. To form a hydrophilic surface that absorbs water, the surface can comprise capillaries. The water absorbed via the capillaries can then be released again at a non-critical location. To form a hydrophobic surface that repels water, the surface can either itself be hydrophobic or comprise a hydrophobic coating.

According to a preferred embodiment of the invention, the at least one surface at risk of icing therefore comprises a hydrophobic coating, for example made of polytetrafluoroethylene (PTFE). PTFE, which is also known under the brand name “Teflon”, has low surface tension, so that water does not adhere to the surface but instead “rolls off”. The contact angle with water is 126°.

Alternatively or additionally, it is proposed that the at least one surface at risk of icing comprises a nanocoating. With the aid of such a coating, the wettability of the surface can likewise be greatly reduced.

Further alternatively or additionally, the at least one surface at risk of icing can comprise a zeolite layer that adsorbs water in an exothermic reaction. On the one hand, this removes water from the surface and, on the other hand, heat is produced by the exothermic reaction and counteracts icing.

The proposed measures for influencing the property of the at least one surface at risk of icing can be carried out or implemented individually or in different combinations. This applies in particular because, as a rule, multiple surfaces of a tank interface are at risk of icing. The multiple surfaces can thus have the same or different surface properties.

The at least one surface at risk of icing can in particular be formed on the front and/or the outer peripheral side of the tank filler neck. The front side and/or outer peripheral surface of the tank filler neck typically forms or form the contact surface or surfaces with the refueling nozzle during a refueling operation, so that the proposed measures to prevent freezing of the refueling nozzle to the tank filler neck are particularly effective here.

Alternatively or additionally, it is proposed that the at least one surface at risk of icing is formed on the front and/or the inner peripheral side of the refueling nozzle. The front and/or inner peripheral surface of the refueling nozzle typically comes or come into contact with the tank filler neck.

The at least one surface at risk of icing does not necessarily have to be flat. In the case of an outer or inner peripheral surface, it can in particular be curved or arcuate. It can also comprise grooves and/or fits. The surface can be chamfered or rounded at the edges.

Since the preferred area of application of the tank filler neck of the tank interface according to the invention is a vehicle which can be operated with hydrogen, such a vehicle comprising a tank interface according to the invention is proposed as well.

### BRIEF DESCRIPTION OF THE DRAWINGS

The invention will be explained in more detail in the following with reference to the accompanying drawings. The figures show:

FIG. 1 a schematic plan view onto a tank filler neck of a tank interface according to the invention,

FIG. 2 a perspective view of the tank filler neck of FIG. 1 and

FIG. 3 a perspective view of a refueling nozzle of a tank interface according to the invention.

### DETAILED DESCRIPTION

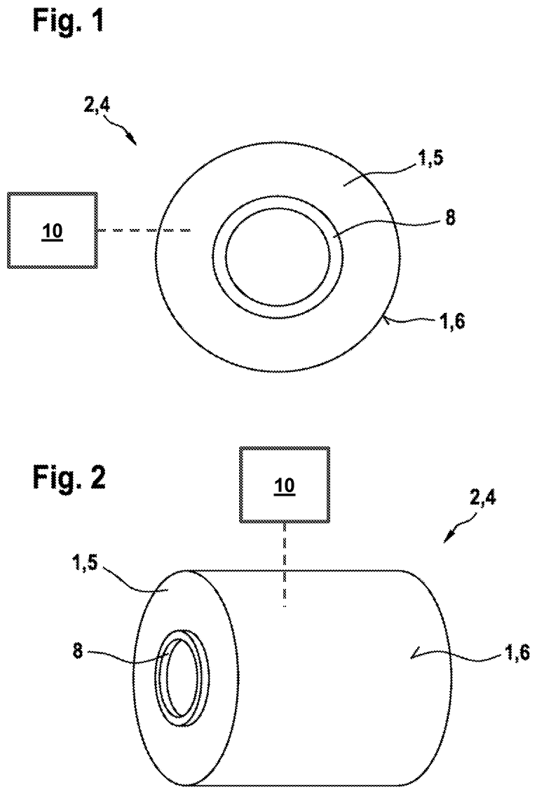

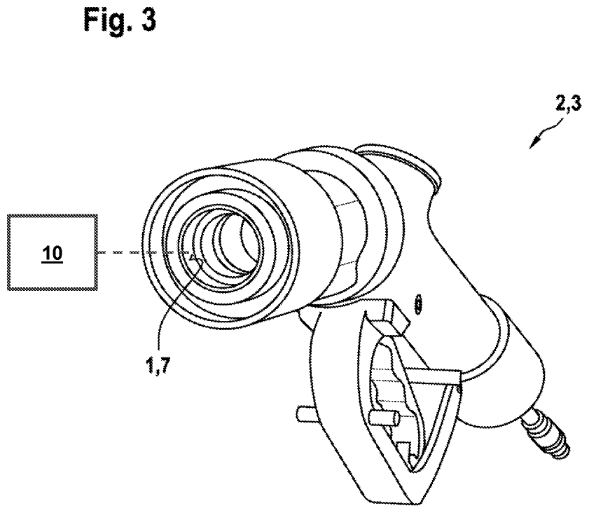

FIGS. 1 and 2 show an example of a tank filler neck 4 of a vehicle which can be operated with hydrogen (not shown). In the present case, the tank filler neck 4 is configured in the form of a hollow cylinder. It comprises a flat front side 5 with a seal 8 and an outer peripheral surface 6. At least the outer peripheral surface 6 comes into contact with a refueling nozzle 3 during a refueling operation. Such a refueling nozzle 3 is shown as an example in FIG. 3.

As can be seen in FIG. 3, the refueling nozzle 3 comprises a type of trunk which, however, is not inserted into but rather onto the tank filler neck 4 of the vehicle to refuel a vehicle which can be operated with hydrogen, so that hydrogen can flow via the refueling nozzle 3 and the tank filler neck 4 into a tank (not shown) of the vehicle.

When the refueling nozzle 3 is attached, an inner peripheral surface 7 of the refueling nozzle 3 comes into contact with the outer peripheral surface 6 of the tank filler neck 4. The contact surfaces form respective surfaces 1 at risk of icing, because they cool considerably when the vehicle is refueled with hydrogen. This is because the temperature of the hydrogen is about −40° C. If condensation then forms on the cooled surfaces, it can freeze. This can cause the refueling nozzle 3 to freeze to the tank filler neck 4.

Even after a refueling operation, condensation can form on the cold surfaces, in particular if the surrounding air is warm and humid. If a new refueling process follows shortly thereafter, the refueling nozzle 3 can freeze to the tank filler neck 4 of the other vehicle.

According to the method according to the invention, the at least one surface 1 which is at risk of icing of a tank interface 2 is therefore heated. Heating can prevent excessive cooling of the surface, so that no condensation forms on said surface or at least does not freeze.

A tank interface 2 according to the invention therefore comprises a heating device (10, shown schematically) for carrying out the method according to the invention. Alternatively or additionally, the at least one surface 1 at risk of icing can have a property that removes, absorbs or adsorbs water. Water can be absorbed via capillaries in the surface 1, for example, and thus removed from the risk area. A coating (not shown) can also be applied to the surface 1, which preferably has a hydrophobic effect, so that water simply rolls off the surface 1. Adsorption of water can be effected by means of a zeolite layer in the surface 1. Adsorption by means of a zeolite layer has the advantage that this process is exothermic, i.e., releases heat, which in turn can be used to heat the surface.

1. A method for keeping free of ice or thawing at least one surface (1) at risk of icing of a tank interface (2), wherein the at least one surface (1) at risk of icing is formed on a refueling nozzle (3) and/or on a tank filler neck (4) of a vehicle configured to be operated with hydrogen,
characterized in that the at least one surface (1) at risk of icing is heated during a refueling operation and/or after a refueling operation.

2. The method according to claim 1,
characterized in that the at least one surface (1) at risk of icing is heated with the aid of a heating cartridge or a heating ring.

3. The method according to claim 1 or 2,
characterized in that the at least one surface (1) at risk of icing is inductively heated.

4. A tank interface (2) comprising at least one surface (1) at risk of icing which is formed on a refueling nozzle (3) and/or on a tank filler neck (4) of a vehicle configured to be operated with hydrogen,
characterized in that the at least one surface (1) at risk of icing is configured to be heated by a heating device and/or is configured in such a way that water is removed, absorbed or adsorbed in a targeted manner.

5. The tank interface (2) according to claim 4,
characterized in that the at least one surface (1) at risk of icing comprises a hydrophobic coating.

6. The tank interface (2) according to claim 4, characterized in that the at least one surface (1) at risk of icing comprises a nanocoating.

7. The tank interface (2) according to claim 4,
characterized in that the at least one surface (1) at risk of icing comprises a zeolite layer that adsorbs water in an exothermic reaction.

8. The tank interface (2) according to claim 4,
characterized in that the at least one surface (1) at risk of icing is formed on a front and/or an outer peripheral side of the tank filler neck (4).

9. The tanker interface (2) according to claim 4,
characterized in that the at least one surface (1) at risk of icing is formed on a front and/or an inner peripheral side of the refueling nozzle (3).

10. A vehicle configured to be operated with hydrogen, the vehicle comprising a tank interface (2) according to claim 4.

11. The method according to claim 2,
characterized in that the at least one surface (1) at risk of icing is inductively heated.

12. The tank interface (2) according to claim 4,
characterized in that the at least one surface (1) at risk of icing is made of polytetrafluoroethylene (PTFE).

13. The tank interface (2) according to claim 4, wherein the at least one surface (1) at risk of icing is configured to be heated by a heating device.

14. The tank interface (2) according to claim 4, further comprising a device (10) for heating the at least one surface (1) at risk of icing.

15. The tank interface (2) according to claim 4, wherein the at least one surface (1) at risk of icing is configured in such a way that water is removed, absorbed or adsorbed in a targeted manner.
